(19) United States
(12) Patent Application Publication
(10) Pub. No.: US 2004/0170767 A1
(43) Pub. Date: Sep. 2, 2004

(54) Coating agents and a process for the preparation of multi-layer coatings

(75) Inventors: Carmen Flosbach, Wuppertal (DE); Kerstin Karpinski, Velbert (DE); Stefanie Matten, Wuppertal (DE); Walter Schubert, Wuppertal (DE)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(73) Assignee: E.I. du Pont de Nemours and Company

(21) Appl. No.: 10/791,996

(22) Filed: Mar. 3, 2004

Related U.S. Application Data
(62) Division of application No. 09/932,124, filed on Aug. 17, 2001, now abandoned.

(51) Int. Cl. B05D 1/36; B05D 3/02

(52) U.S. Cl. 427/385.5; 427/407.1

(57) ABSTRACT

Coating agents with resin solids of

(a) 10 wt-% to 80 wt-% of a non-aromatic polyester polyol,

(b) 0 wt-% to 70 wt-% of at least one constituent selected from the group consisting of hydroxyl-functional binders that are different from polyester polyol (a), hydroxyl-functional reactive thinners and combinations thereof, and

(c) 20 wt-% to 60 wt-% of at least one cross-linking agent for the hydroxyl-functional components (a) and (b),

wherein the polyester polyol (a) has a calculated molecular mass from 600 to 1400, an acid value from 0 to 30 mg KOH/g and an hydroxyl value from 250 to 600 mg KOH/g with a calculated hydroxyl functionality from 4.5 to 10, and is composed of components which comprise

(a1) hydroxyl components comprising 0 wt-% to 20 wt-% of at least one diol and 80 wt-% to 100 wt-% of at least one polyol having 3 to 6 hydroxyl groups,

(a2) carboxyl components comprising 0 wt-% to 20 wt-% of at least one monocarboxylic acid and 80 wt-% to 100 wt-% of at least one dicarboxylic acid, and optionally

(a3) at least one hydroxycarboxylic acid component, the sum of the percentages by weight of components (a) to (c), of components (a1) and of components (a2) being 100% in each case.

### FIELD OF THE INVENTION

The invention relates to coating agents and to a process for the preparation of multi-layer coatings using the coating agents, particularly for the preparation of external clear coat or top coat layers of multi-layer coatings.

### BACKGROUND OF THE INVENTION

Polyester polyols with high hydroxyl functionality are known, for example, from U.S. Pat. No. 5,136,014, inter alia as binders. They are molecules having a dendritic structure and a large number of hydroxyl terminal groups. The suitability of such polyester polyols as binders in coating agents is only very limited, however, as J. Huybrechts reports (Oil and Color Chemists' Association, International Conference Surcon '97, 24th September 1997, Technical Programme Session 3, Paper 4 “Star and Hyperbranched polymers for low VOC polyurethane coatings”, pages 25 to 26).

The present invention satisfies the demand for a coating agent, particularly useful for automobiles and trucks, that is resistant to chemicals and scratching that occur when the automobile or truck is washed in a typical commercial car wash. The coating agent contains a polyester polyol binder with high hydroxyl functionality and at the same time has a high hydroxyl group content, the polyester polyol has good compatibility with other hydroxyl-functional binders, solvents and cross-linking agents.

### SUMMARY OF THE INVENTION

The invention provides a coating agent of which the resin solids are composed of

(a) 10 wt-% to 80 wt-%, preferably 15 wt-% to 50 wt-% of a non-aromatic polyester polyol,

(b) 0 wt-% to 70 wt-%, preferably 30 wt-% to 60 wt-% of one or more hydroxyl-functional binders that are different from the polyester polyol (a) and/or hydroxyl-functional reactive thinners, and

(c) 20 wt-% to 60 wt-% of at least one cross-linking agent for the hydroxyl-functional components (a) and (b), wherein the polyester polyol (a) has a calculated molecular mass from 600 to 1400, an acid value from 0 to 30 mg KOH/g and an hydroxyl value from 250 to 600 mg KOH/g with a calculated hydroxyl functionality from 4.5 to 10, and is composed of from components which comprise

(a1) hydroxyl components comprising 0 wt-% to 20 wt-% of at least one diol and 80 wt-% to 100 wt-% of at least one polyol having 3 to 6 hydroxyl groups,

(a2) carboxyl components comprising 0 wt-% to 20 wt-% of at least one monocarboxylic acid and 80 wt-% to 100 wt-% of at least one dicarboxylic acid, and optionally

(a3) at least one hydroxycarboxylic acid component, the sum of the percentages by weight of components (a) to (c), of components (a1) and of components (a2) being 100% in each case.

### DETAILED DESCRIPTION OF THE EMBODIMENTS

The polyester polyol (a) preferably has a calculated molecular mass from 800 to 1200, an hydroxyl value from 270 to 400 mg KOH/g and a calculated hydroxyl functionality from 4.8 to 8.

The polyester polyol (a) is a non-aromatic polyester polyol composed of non-aromatic polyester building blocks. The polyester polyol (a) may contain aromatic structures in small quantity proportions of, for example, up to 2 wt-% (calculated as C₆, molecular mass 72). These small quantity proportions of aromatic structures may, however, be caused merely by technical impurities of the inherently non-aromatic polyester building blocks.

The polyester polyol (a) is preferably composed of 30 wt-% to 60 wt-%, preferably 40 wt-% to 55 wt-% of at least one hydroxyl component (a1), 30 wt-% to 70 wt-%, preferably 45 wt-% to 60 wt-% of at least one carboxyl component (a2) and 0 wt-% to 10 wt-%, preferably 0 wt-% of at least one hydroxycarboxylic acid component (a3). The sum of the percentages by weight of components (a1) to (a3) is 100 wt-%, and does not take into account water of reaction formed during the synthesis of polyester polyol (a).

The hydroxyl components (a1) contained in the polyester polyol (a) are composed of 0 wt-% to 20 wt-% of at least one (cyclo)aliphatic diol and 80 wt-% to 100 wt-%, preferably exclusively of at least one (cyclo)aliphatic polyol having 3 to 6 hydroxyl groups.

Examples of (cyclo)aliphatic diols as hydroxyl components (a1) for the composition of the polyester polyol (a) include ethylene glycol, 1,2-propylene glycol and 1,3-propylene glycol, butane-1,3-diol, butane-1,4-diol and butane-2,3-diol, pentane-1,5-diol, hexane-1,6-diol, trimethylhexane diol, diethylene glycol, triethylene glycol, hydrogenated bisphenols, 1,4-cyclohexane dimethanol, neopentyl glycol, butylethylpropane diol. Hexane-1,6-diol, neopentyl glycol, butylethylpropane diol are preferred. Examples of (cyclo)aliphatic polyols having 3 to 6 hydroxyl groups as hydroxyl components (a1) for the composition of the polyester polyol (a) include glycerol, trimethylolpropane, trimethylolethane, pentaerythritol, dipentaerythritol, ditrimethylolpropane, sorbitol, mannitol. Glycerol, trimethylolpropane and pentaerythritol are preferred, particularly trimethylolpropane and pentaerythritol.

The carboxyl components (a2) contained in the polyester polyol (a) are composed of 0 wt-% to 20 wt-% of at least one (cyclo)aliphatic monocarboxylic acid and 80 wt-% to 100 wt-%, preferably exclusively of at least one dicarboxylic acid.

Examples of (cyclo)aliphatic monocarboxylic acids as carboxyl components (a2) for the composition of the polyester polyol (a) include saturated fatty acids, such as, e.g., 2-ethylhexanoic acid, isononanoic acid, coconut fatty acid, decanoic acid, dodecanoic acid, tetradecanoic acid, stearic acid, palmitic acid. Isononanoic acid, coconut fatty acid are preferred.

Examples of dicarboxylic acids as carboxyl components (a2) for the composition of the polyester polyol (a) include (cyclo)aliphatic dicarboxylic acids, such as, tetrahydrophthalic acid, hexahydrophthalic acid, 1,3- and 1,4-cyclohexane dicarboxylic acid, succinic acid, adipic acid, sebacic acid, azelaic acid, dodecane dicarboxylic acid but also maleic acid, fumaric acid and dimer fatty acids, preferably, C₃₆ dimer fatty acids. Dimer fatty acids are technical mixtures which may also contain olefinic and/or aromatic carbon-carbon double bonds. Hexahydrophthalic acid, 1,4-cyclohexane dicarboxylic acid, adipic acid and dimer fatty acid are preferred. If they exist, the corresponding dicarboxylic acid anhydrides may also be used instead of the dicarboxylic acids.

It is particularly preferred if the polyester polyol (a) contains dimer fatty acid as one of at least two dicarboxylic acids (a2), namely, corresponding to a weight ratio of 5 wt-% to 45 wt-% of dimer fatty acid and 55 wt-% to 95 wt-% of at least one further dicarboxylic acid.

Optionally, at least one (cyclo)aliphatic hydroxycarboxylic acid (a3) may also participate in the composition of the polyester polyol (a), but in a proportion of not more than 10 wt-% of the components (a1) to (a3) used for the composition of polyester polyol (a). Examples of hydroxycarboxylic acids include 12-hydroxystearic acid, 6-hydroxyhexanoic acid, citric acid, tartaric acid, dimethylolpropionic acid. If they exist, the corresponding lactones may also be used instead of the monohydroxycarboxylic acids.

The polyester polyol (a) is very branched and composed randomly of components (a1) to (a3). It is soluble in organic solvents and highly compatible with other hydroxyl-functional binders (b) and cross-linking agents (c).

The polyester polyol (a) may be prepared by polycondensation of the above-mentioned components (a1), (a2) and optionally (a3), components (a1) to (a3) being selected according to type and quantity such that the above-mentioned characteristic values (calculated molecular mass, calculated hydroxyl functionality, hydroxyl and acid values) are obtained for the polyester polyol (a). Polycondensation may be carried out by the conventional methods known to the skilled person, for example, in the presence of conventional esterification catalysts and at elevated temperatures from, e.g., 180° C. to 250° C., for example, in the melt. Optionally, entrainers, such as, e.g., xylene, may also be used. Components (a1) to (a3) may be reacted together to polyester polyol (a) in a multi-step or preferably one-step synthesis process. All the components (a1) to (a3) are preferably charged at the same time and heated together, optionally, melted and polycondensed with one another to the polyester polyol (a).

Component (b), which is optional but preferably accounts for 30 wt-% to 60 wt-% of the resin solids, is one or more hydroxyl-functional binder(s) different from polyester polyol (a) and/or reactive thinners, particularly hydroxyl-functional (meth)acrylic copolymer resins, hydroxyl-functional polyurethane resins, hydroxyl-functional polyester resins different from polyester polyol (a) and/or hydroxyl-functional reactive thinners.

Examples of hydroxyl-functional binders (b) include conventional hydroxyl-functional polyester or polyurethane resins having a number average molecular mass from 500 to 5000, preferably from 1000 to 3000 and hydroxyl values from 30 to 250, preferably from 50 to 200 mg KOH/g and hydroxyl-functional (meth)acrylic copolymer resins having a number average molecular mass from 1000 to 10,000 and hydroxyl values from 30 to 200, preferably from 50 to 180 mg KOH/g.

Examples of hydroxyl-functional reactive thinners (b) include low molecular weight compounds having a molecular mass of, for example, below 500, at least two hydroxyl groups per molecule and hydroxyl values in the range from 250 to 700 mg KOH/g. Oligomeric or polymeric polyols are suitable, such as polyether polyols, oligoester polyols, polycarbonate polyols, polycaprolactone polyols and oligourethane polyols.

Component (c) of the resin solids is a cross-linking agent for the hydroxyl-functional components (a) and (b). More particularly, it is a conventional cross-linking agent component for the cross-linking of hydroxyl-functional binders, such as, aminoplastic resins, particularly melamine resins, polyisocyanates of which the NCO groups may be blocked, and/or transesterification cross-linking agents, such as, tris(alkoxycarbonylamino)triazines.

Preferred cross-linking agents (c) are free polyisocyanates; in that case, the coating agents according to the invention are prepared only shortly before application by mixing components stored separately from one another, one of the components containing the free polyisocyanate cross-linking agent.

Examples of polyisocyanates that may be used in the free or blocked form as cross-linking agents (c) include nonane triisocyanate, tetramethylxylylene diisocyanate and (cyclo)aliphatic diisocyanates, such as 1,6-hexane diisocyanate, trimethylhexane diisocyanate, 1,12-dodecane diisocyanate, cyclohexane diisocyanate, isophorone diisocyanate, biscyclohexylmethane diisocyanate or mixtures thereof, and polyisocyanates derived from such diisocyanates, for example, those containing heteroatoms in the radical linking the isocyanate groups. Examples thereof include polyisocyanates containing carbodiimide groups, allophanate groups, isocyanurate groups, uretidione groups, urethane groups and/or biuret groups.

The conventional coating polyisocyanate cross-linking agents are particularly suitable, particularly, e.g., tris-(6-isocyanatohexyl)biuret, isophorone diisocyanate isocyanurate or hexane diisocyanate isocyanurate.

Suitable blocking agents for the polyisocyanate cross-linking agents described above include the conventional, for example, CH-acidic, NH-, SH- or OH-functional blocking agents. Examples include acetyl acetone, acetoacetic acid alkyl esters, malonic acid dialkyl esters, aliphatic or cycloaliphatic alcohols, oximes, lactams, imidazoles, pyrazoles.

The coating agents according to the invention in the state ready for application have a solids content, formed from the resins solids and optionally contained non-volatile additives and optionally contained pigments, from 40 wt-% to 80 wt-%. They contain, as volatile constituents, organic solvents and/or water; but preferably are non-aqueous coating agents.

Examples of organic solvents that may be used in the coating agents include glycol ethers, such as, butyl glycol, butyl diglycol, dipropylene glycol dimethyl ether, dipropylene glycol monomethyl ether, ethylene glycol dimethylether; glycol ether esters, such as, ethyl glycol acetate, butyl glycol acetate, butyl diglycol acetate, methoxypropyl acetate; esters, such as, butyl acetate, isobutyl acetate, amyl acetate; ketones, such as, methyl ethyl ketone, methyl isobutyl ketone, diisobutyl ketone, cyclohexanone, isophorone; alcohols, such as, methanol, ethanol, propanol, butanol; aromatic hydrocarbons, such as, xylene, Solvesso® 100 (mixture of aromatic hydrocarbons with a boiling range from 155° C. to 185° C.), Solvesso® 150 (mixture of aromatic hydrocarbons with a boiling range from 182° C. to 202° C.) and aliphatic hydrocarbons.

The coating agents may contain conventional coating additives in amounts of, for example, up to 5 wt-%, based on coating agent ready for application, for example, leveling agents, rheology influencing agents, such as, pyrogenic silica, urea group-containing reaction products of amines and polyisocyanates (“sagging control agents”), catalysts, colorants, light stabilizers, UV absorbers, antioxidants, polymer microparticles, such as, microgels, substances releasing formaldehyde.

Depending on the intended use as clear coat coating agent or as opaque coating agent, the coating agents may be unpigmented, transparent or contain opaque pigments. They may therefore contain fillers and/or transparent, color-imparting and/or special effect-imparting pigments. Examples of inorganic or organic color-imparting pigments include titanium dioxide, micronized titanium dioxide, iron oxide pigments, carbon black, azo pigments, phthalocyanine pigments, quinacridone or pyrrolopyrrole pigments. Examples of special effect-imparting pigments include metallic pigments, e.g., of aluminum, copper or other metals; interference pigments, e.g., metal oxide-coated metallic pigments, e.g., titanium dioxide-coated or mixed oxide-coated aluminum, coated mica, e.g., titanium dioxide-coated mica and graphite effect-like special-effect pigments. Examples of suitable fillers include silica, aluminum silicate, barium sulfate, calcium carbonate and talc.

The coating agents according to the invention are preferably formulated on the basis of organic solvents. They may also, however, be in the water-thinnable form. Conversion to the aqueous form may take place in a conventional manner known to the skilled person by neutralization with bases, such as, amines and/or amino alcohols and/or by the addition of nonionic emulsifiers and conversion to the aqueous phase. Organic solvents may be removed before or after the addition of water, for example, by distillation. Conversion to the aqueous phase may take place, for example, using rotor-stator units.

The coating agents according to the invention may be used, for example, in the preparation of multi-layer coatings on any substrates, for example, of metal, plastic or substrates composed of a mixed construction of metal and plastic, and in particular for the preparation of an external pigmented top coat or transparent clear coat layer of a multi-layer coating. The external coating layer may be applied, for example, by the wet-in-wet method to a precoating applied to a substrate, whereupon both layers are cured together. The invention also relates, therefore, to the process for the preparation of multi-layer coatings. The preferably non-aqueous coating agents according to the invention may be applied preferably as transparent clear coats to layers applied from aqueous or solvent-containing color-imparting and/or special effect-imparting base coats.

The coating agents according to the invention are applied by known methods, particularly by spraying in a dry layer thickness of, for example, 15 μm to 50 μm. After a generally proven short flash-off phase, the applied coating agent is cross-linked preferably by heating. The baking temperatures are preferably from 60° C. to 160° C., particularly preferably from 120° C. to 150° C. The curing times are, for example, of the order of magnitude of 20 minutes to 40 minutes. A cross-linked, hard, glossy lacquer coating is obtained.

The coating agents according to the invention are particularly suitable for the preparation of the above-mentioned multi-layer coatings in the field of automotive OEM and repair finishing, both of automotive bodies and body parts.

The coatings applied from the coating agents according to the invention and cured are characterized by good resistance to chemicals, outstanding mar resistance and very good optical properties.

### EXAMPLES

### Example 1

### Preparation of a Solution of a Polyester Polyol (a)

A mixture of 911 g of trimethylol propane, 748 g of hexahydrophthalic anhydride and 138 g of dimer fatty acid (Empol® 1008 from Henkel) was heated to 250° C. Esterification was carried out with water separation until an acid value of less than 5 mg KOH/g was obtained. After cooling to below 125° C., the solids content was adjusted to 70% (1 h/105° C.) with 90 g of xylene and 641 g of methoxypropyl acetate.

The polyester polyol had an hydroxyl value of 345 mg KOH/g and an acid value of 4.5 mg KOH/g. The calculated hydroxyl functionality was 5.6 and the calculated molecular mass was 920.

Bases I and II were prepared by mixing the following constituents.

| | Base I | Base II |
|---|---|---|
| Polyester polyol (a) of | — | 30 |
| Example 1 | | |
| Polyester polyol (b) | 70 | 40 |
| Light stabilizer of the HALS | 1.4 | 1.4 |
| type | | |
| UV absorber based on | 1.4 | 1.4 |
| benztriazole | | |
| Commercial leveling agent | 0.5 | 0.5 |
| (silicone oil) | | |
| Ethoxypropyl acetate | 9 | 9 |
| Butyl diglycol acetate | 1 | 1 |
| Solvesso ® 100 | 10.2 | 10.2 |
| Solvesso ® 150 | 2 | 2 |
| Butyl acetate | 4.5 | 4.5 |

Polyester polyol (b): 70 wt-% solution of a polyester polyol composed of neopentyl glycol, trimethylolpropane, hexahydrophthalic anhydride and coconut fatty acid, with an acid value of 13 mg KOH/g and an hydroxyl value of 136 mg KOH/g, a calculated hydroxyl functionality of 3.8 and a calculated molecular mass of 1500 in Solvesso® 100.

The bases 1 and 11 were mixed in each case with different hardener solutions 1 to 3.

Hardener solution 1: Mixture of 81 g of hexamethylene diisocyanate isocyanurate, 9.5 g of Solvesso® 100 and 9.5 g of butyl acetate.

Hardener solution 2: Mixture of 60 g of hexamethylene diisocyanate isocyanurate, 17 g of isophorone diisocyanate isocyanurate, 11.5 g of Solvesso® 100 and 11.5 g of butyl acetate.

Hardener solution 3: Mixture of 22.5 g of hexamethylene diisocyanate isocyanurate, 43.5 g of isophorone diisocyanate isocyanurate, 17 g of Solvesso® 100 and 17 g of butyl acetate. The clear coat coating agents obtained by mixing base and hardener solution were applied by electrostatic spraying in a dry layer thickness of 35 μm to test panels provided with a three-layer precoating of cathodic electrodeposition coating primer, primer surfacer and aqueous base coat layer, the latter having been dried for 10 minutes at 80° C. After a 10 minute flash-off at 60° C., the clear coat coating layer was baked for 30 min at 140° C. (object temperature).

Table 1 gives mixing ratios between bases and cross-linking agent solutions and results of technological tests carried out on the multi-layer coatings.

TABLE 1
Clear coats

| | 1 | 2 | 3 | 4 | 5 | 6 |
|---|---|---|---|---|---|---|
| 100 parts by wt. base | I | I | I | II | II | II |
| 50 parts by wt. cross- | 1 | 2 | 3 | 1 | 2 | 3 |
| linker solution | | | | | | |
| Mar resistance¹⁾ | 60 | 58 | 25 | 80 | 62 | 40 |
| Tree resin²⁾ | 37 | 38 | 45 | 45 | 53 | 56 |
| Pancreatin²⁾ | 35 | 35 | 43 | 39 | 46 | 50 |
| Sulfuric acid, | 40 | 40 | 49 | 44 | 50 | 50 |
| 1%²⁾ | | | | | | |
| Sulfuric acid, | 7/23 | 9/25 | 11/28 | 8/no | 10/no | 14/no |
| droplet test, 36%, | | | | etching | etching | etching |
| 65° C.³⁾ | | | | | | |
| FAM test⁴⁾ | 4-5 | 4-5 | 4 | 0-1 | 0 | 0 |
| ¹⁾The residual gloss in % was measured in each case after one hour's reflow at 60° C. (ratio of initial gloss of the multi-layer coating to its gloss after scratching, gloss measurement in each case at an angle of illumination of 20°). Scratching was carried out using the laboratory- | | | | | | |
| # scale Amtec Kistler car wash (cf. Th. Klimmasch and Th. Engbert, Development of a uniform laboratory test method for assessing the car wash resistance of automotive top coats, in DFO Proceedings 32, pages 5 Proceedings of the Seminar on 29. and 30.4.97 in Cologne, Published by Deutsche Forschungsgesellschaft fur Oberflachenbehandlung e.V., Adersstraβe 94, 40215 Dusseldorf). | | | | | | |

²⁾Temperature gradient determination, assessment 24 h after exposure, occurrence of first marking at ° C.
³⁾Determination of exposure time in minutes after which swelling/etching occurs
⁴⁾Wads of cotton wool soaked with a mixture of 90 wt. % of white spirit and 10 wt - % of ethanol were placed on the coating surface to be tested and covered for 10 minutes with a watchglass. The surface was then wiped and assessed visually immediately. Characterisitic value 1 to 5; 0 = no swelling/softening, 5 = complete softing.

Glossy, smooth surfaces were obtained both with the comparison clear coats 1 to 3 and with the clear coats 4 to 6 according to the invention. No haze occurred with any of the clear coat layers.

What is claimed is:

1. Coating agents with resin solids comprising
(a) 10 wt-% to 80 wt-% of a non-aromatic polyester polyol,
(b) 0 wt-% to 70 wt-% of at least one constituent selected from the group consisting of hydroxyl-functional binders that are different from polyester polyol (a), hydroxyl-functional reactive thinners and combinations thereof, and
(c) 20 wt-% to 60 wt-% of at least one cross-linking agent for the hydroxyl-functional components (a) and (b), wherein the polyester polyol (a) has a calculated molecular mass from 600 to 1400, an acid value from 0 to 30 mg KOH/g and an hydroxyl value from 250 to 600 mg KOH/g with a calculated hydroxyl functionality from 4.5 to 10, and is composed of components which comprise
(a1) hydroxyl components comprising 0 wt-% to 20 wt-% of at least one diol and 80 wt-% to 100 wt-% of at least one polyol having 3 to 6 hydroxyl groups,
(a2) carboxyl components comprising 0 wt-% to 20 wt-% of at least one monocarboxylic acid and 80 wt-% to 100 wt-% of at least one dicarboxylic acid, and optionally
(a3) at least one hydroxycarboxylic acid component, the sum of the percentages by weight of components (a) to (c), of components (a1) and of components (a2) being 100% in each case.

2. Coating agents according to claim 1, wherein the polyester polyol (a) comprises 30 wt-% to 60 wt-% of at least one hydroxyl component (a1), 30 wt-% to 70 wt-% of at least one carboxyl component (a2) and 0 wt-% to 10 wt-% of at least one hydroxycarboxylic acid component (a3).

3. Coating agents according to claim 1, wherein the hydroxyl component (a1) consists of at least one (cyclo)aliphatic polyol having 3 to 6 hydroxyl groups.

4. Coating agents according to claim 1, wherein the carboxyl component (a2) consists of at least one dicarboxylic acid.

5. Coating agents according to claim 1, wherein the polyester polyol (a) comprises dimer fatty acid as one of at least two dicarboxylic acids of the carboxyl component (a2) corresponding to a weight ratio from 5 wt-% to 45 wt-% of dimer fatty acid and 55 wt-% to 95 wt-% of at least one additional dicarboxylic acid.

6. Coating agents according to claim 1, wherein the cross-linking agent (c) is selected from the group consisting of aminoplastic resins, free polyisocyanates, blocked polyisocyanates, transesterification cross-linking agents or combinations thereof.

7. Coating agents according to claim 1, selected from the group consisting of aqueous coating agents and coating agents based on organic solvents.

8. A process which comprises applying a multi-layer coating on a substrate using a coating agent according to claim 1 and curing said coating.

9. A process for forming a coating layer as one coating layer of a multi-layer coating which comprises applying to a substrate a coating layer selected from the group consisting of external pigmented top coat layer and transparent clear coat layer, said coating layer being applied from the coating agent according to claim 1 and curing said coating layer.

10. A process according to claim 8, wherein the substrates are substrates selected from the group consisting of automotive bodies and body parts.
